(19) United States
(12) Patent Application Publication
(10) Pub. No.: US 2014/0352823 A1
(43) Pub. Date: Dec. 4, 2014

(54) SYSTEMS AND METHODS OF HANDLING AN OFF-GAS CONTAINING CARBON MONOXIDE

(71) Applicant: Hatch Ltd., Mississauga (CA)

(72) Inventors: Michael Trovant, Toronto (CA); Daniel Richard Kulchyski, Oakville (CA); Mirza Ridwanul Haque, Mississauga (CA); Bert Wasmund, Milton (CA)

(73) Assignee: Hatch Ltd., Mississauga, ON (CA)

(21) Appl. No.: 14/365,830

(22) PCT Filed: Dec. 13, 2012
(86) PCT No.: PCT/CA2012/001143

§ 371 Date: Jun. 16, 2014

Related U.S. Application Data
(60) Provisional application No. 61/576,209, filed on Dec. 15, 2011.

(51) Int. Cl. F16L 41/00

(52) U.S. Cl. CPC F16L 41/00
USPC 137/602

(57) ABSTRACT

An uptake apparatus is arranged to extract a stream of off-gas containing carbon monoxide from a process vessel. At least one gas conditioning train receives and conditions the stream. An outlet expels at least a portion of the stream. A portion of the stream is separated to form a recycle stream. An eductor apparatus combines the stream with the recycle stream, to decrease the temperature and increase the static pressure of the stream. The stream is maintained at a positive gauge pressure.

### TECHNICAL FIELD

The present disclosure relates to the handling of industrial off-gas, and particularly to systems and methods designed to prevent explosion and leakage of carbon monoxide gas into the working environment.

### BACKGROUND

The following paragraphs are not an admission that anything discussed in them is prior art or part of the knowledge of persons skilled in the art.

Some industrial processes produce carbon monoxide-rich off-gas, including blast furnaces, coke ovens, nickel laterite smelters, ilmenite smelters, gasifiers, and calcium carbide smelters. This off-gas may also contain hydrogen gas, hydrocarbons, and other components. The production of calcium carbide in a submerged arc furnace, for example, uses a feed mixture of coke and lime in the following reaction.

CaO+3C→CaC₂+CO

Generally, carbon monoxide-rich off-gas may be handled by an off-gas system, which ducts the off-gas from the process vessel where it is produced. However, carbon monoxide is a flammable substance that can form an explosive mixture with air. Consequently, the prevention of air infiltration into an off-gas handling system is desirable.

In a negative pressure gas handling system, air infiltration into the off-gas system is addressed by attempting to thoroughly seal all potential sources of leaks, particularly joints and pipe connections. This process is not trivial; for example, it may involve hand-welding a steel band around the full circumference of a pipe connection and then applying special paint. However, long term deterioration of such joints may eventually lead to leakage of air into the system, and this leakage may be difficult to detect without in situ monitoring equipment within the ductwork, which, due to the hostile environment, may have poor reliability. Over time, there may be an increased risk of forming an undetected explosive gas mixture within the off-gas system.

Off-gas handling systems may include a means for dust removal. Wet gas cleaning and dry gas cleaning are two dust removal approaches.

Wet gas cleaning involves passing the off-gas through a scrubber, where it is sprayed by a liquid or passed through a pool of liquid. The liquid may be water, for example. Dust particles are removed by precipitation in the liquid scrubbing agent. Pollutant gases may also be removed by absorption or dissolution into the scrubbing agent. Wet gas cleaning tends to reduce the temperature and volume of the clean exhaust stream, making for smaller size requirements on downstream equipment. However, a wet system may produce effluent streams which require treatment prior to disposal.

The second approach to dust removal is dry gas cleaning. This may involve passing the off-gas through a series of filters, such as baghouse filters, electrostatic precipitators, or other dry components to remove dust particles. Dry dust can be captured and potentially used instead of being expelled in an effluent stream. However, volatile compounds may condense during dry gas cleaning, which may block equipment, such as the baghouse filters. To prevent condensation, measures may be taken to maintain sufficiently high temperatures during dust removal. Furthermore, because the off-gas is not cooled to the same extent during cleaning, downstream equipment size requirements may be higher than comparable wet systems. Dedicated gas cooling equipment may also be required downstream of the cleaning stage.

### SUMMARY OF THE DISCLOSURE

The following summary is intended to introduce the reader to the more detailed description that follows and not to define or limit the claimed subject matter.

According to an aspect of the present disclosure, a system for handling an off-gas containing carbon monoxide at a positive gauge pressure is provided. The system may include: an uptake apparatus for extracting a stream of the off-gas from a process vessel; at least one gas conditioning train, for receiving and conditioning the stream; a junction for separating the stream to form at least a recycle stream and an outlet stream; an outlet for expelling the outlet stream; and an eductor apparatus for receiving and combining the stream with the recycle stream, to decrease the temperature and increase the static pressure of the stream.

The eductor apparatus may be arranged upstream from the at least one gas conditioning train. The eductor apparatus may include a first inlet duct for receiving the stream, a second inlet duct for receiving the recycle stream, and an outlet duct for expelling the stream. The outlet duct may be oriented generally vertically so that the stream is expelled generally in a vertically downward direction. The system may further include a drop-out box positioned below the outlet duct for receiving dust particles entrained in the stream.

The eductor apparatus may include a throat, and the recycle stream is expelled through the throat. A cross sectional area of the throat may be adjustable to control a flow velocity of the recycle stream. The cross sectional area may be adjusted by varying a vertical position of a conical member within the throat.

The system may further include a recycle fan for receiving the recycle stream from the junction and pressurizing the recycle stream.

The uptake apparatus may be adapted to cool the stream. The uptake apparatus may include a water-cooled duct. The uptake apparatus may include an ambient-cooling duct. The water-cooled duct and the ambient-cooling duct may be connected in series. The uptake apparatus may be arranged so that an outlet of the uptake apparatus is at a higher elevation than an inlet of the uptake apparatus.

The at least one gas conditioning train may include an off-gas fan for pressurizing the stream, a dry dust collector for cleaning the stream, and a cooler for cooling the stream. The off-gas fan may receive the stream from the eductor apparatus, the dry dust collector may receive the stream from the off-gas fan, and the cooler may receive the stream from the dry dust collector. The off-gas fan may be arranged so that an inlet of the off-gas fan is at a higher elevation than an inlet of the uptake apparatus.

The system may include two or more of the gas conditioning trains.

According to another aspect of the present disclosure, a method of handling an off-gas containing carbon monoxide at a positive gauge pressure is provided. The method may include: extracting a stream of the off-gas from a process vessel; passing the stream through at least one gas conditioning train to condition the stream; separating the stream to form an outlet stream and a recycle stream; expelling the outlet stream; and combining the stream with the recycle stream, to decrease the temperature and increase the static pressure of the stream.

The stream and the recycle stream may be combined upstream from the at least one gas conditioning train. The step of passing the stream through the at least one gas conditioning train may include pressurizing the stream, cleaning the stream, and cooling the stream.

The stream may be pressurized using an off-gas fan, and the method may further include monitoring a pressure of the process vessel, and varying a flow rate of the off-gas fan based on the pressure.

The method may further include: pressurizing the recycle stream using a recycle fan; and monitoring a temperature of the stream after being combined with the recycle stream, and varying a flow rate of the recycle fan based on the pressure.

The stream and the recycle stream may be combined using an eductor apparatus, and the method may further include adjusting a flow velocity of the recycle stream in the eductor apparatus. The method may further include monitoring a pressure differential between the recycle stream and the stream after being combined with the recycle stream in the eductor apparatus, and adjusting the flow velocity of the recycle stream based on the pressure differential.

The stream may be extracted using an uptake apparatus, and the method may further include cooling the stream in the uptake apparatus. The method may further include flowing the stream through a water-cooled duct of the uptake apparatus. The method may further include flowing the stream through an ambient-cooling duct of the uptake apparatus. The stream may be flowed upwardly between an inlet of the uptake apparatus and an outlet of the uptake apparatus arranged at a higher elevation than the inlet. The stream may be flowed upwardly between the inlet of the uptake apparatus and an inlet of the gas conditioning train arranged at a higher elevation than the inlet of the uptake apparatus.

The method may include passing the stream through two or more of the gas conditioning trains.

### BRIEF DESCRIPTION OF THE DRAWINGS

In order that the claimed subject matter may be more fully understood, reference will be made to the accompanying drawings, in which:

FIG. 1 is a schematic representation of an example of a gas handling system;

FIG. 2 is a flow diagram of a method of using the system of FIG. 1;

FIG. 3 is a detailed side view of an uptake apparatus and an eductor apparatus of the system of FIG. 1;

FIG. 4 is a further detailed side view of the eductor apparatus of the system of FIG. 1;

FIG. 5 is a schematic representation of another example of a gas handling system, including parallel gas conditioning trains; and

FIG. 6 is a schematic representation of yet another example of a gas handling system, including control loops.

### DETAILED DESCRIPTION

In the following description, specific details are set out to provide examples of the claimed subject matter. However, the examples described below are not intended to define or limit the claimed subject matter. It will be apparent to those skilled in the art that many variations of the specific examples may be possible within the scope of the claimed subject matter.

For simplicity and clarity of illustration, where considered appropriate, reference numerals may be repeated among the drawings to indicate corresponding or analogous elements or steps.

Off-gas systems designed to handle carbon monoxide-rich gas may require special design consideration due to its flammable and poisonous properties. As described herein, in an industrial process that produces carbon monoxide as a component of the off-gas mixture, a positive gauge pressure system is used to remove the off-gas from the one or more process vessels, clean and cool the off-gas, and direct the off-gas to a downstream outlet for further use or storage. The system is maintained above atmospheric pressure, such that any leakage involves gas flowing out of the off-gas system. Air infiltration against the pressure gradient and into the off-gas system is generally not possible, and thus the formation of explosive gas mixtures may be avoided.

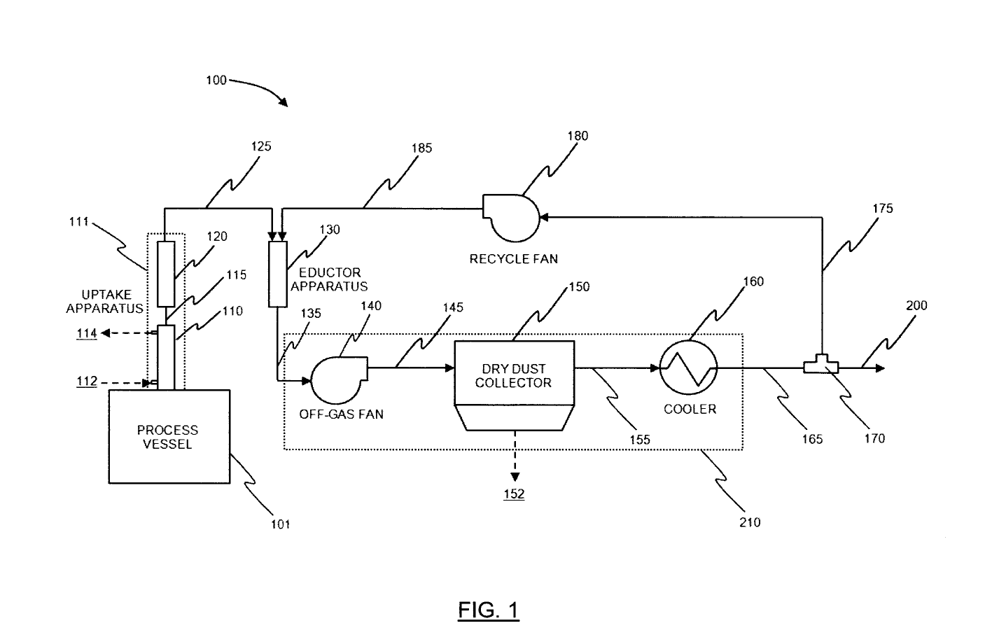

Referring to FIG. 1, an example of a system is illustrated generally at 100. The system 100 includes a process vessel 101, an uptake apparatus 111, an eductor apparatus 130, an off-gas fan 140, a dry dust collector 150, a cooler 160, and a recycle fan 180.

The process vessel 101 may be an enclosed vessel which produces carbon monoxide-rich gas as the primary product, or as a by-product, of an industrial process. As an example, the process vessel 101 may be an electric arc furnace, used for the manufacture of calcium carbide. The process vessel 101 includes at least one outlet for delivering off-gas downstream to the system 100.

As illustrated, the uptake apparatus 111 may include a water-cooled duct 110 and an ambient-cooling duct 120, connected in series. The water-cooled duct 110 may be an upwardly sloping duct of double-wall or channel-type construction, with a plenum between inner and outer walls through which cooling water 112 is fed. The cooling water 112 enters the plenum of the water-cooled duct 110, and cools the hot off-gas extracted from the process vessel 101 by forced convection. Used cooling water 114 is then expelled from the water-cooled duct 110. Orientation of the cooling water 112 and the used cooling water 114 may be reversed, so that the water runs counterflow to the off-gas. In some examples, the used cooling water 114 may be cooled, e.g., by passing it through a heat exchanger, and then recirculated as the cooling water 112.

The ambient-cooling duct 120 may be an upwardly sloping duct extending from an outlet of the water-cooled duct 110. An off-gas stream 115, which has been cooled by the water-cooled duct 110, enters the ambient-cooling duct 120 and is further cooled by radiation and natural convection, e.g., ambient cooling. A semi-cooled off-gas stream 125 exits from an outlet of the ambient-cooling duct 120. As an example, and not intended to be limiting, the temperature in the semi-cooled off-gas stream 125 may be approximately 450° C.

In the example illustrated, the water-cooled duct 110 is arranged upstream from the ambient-cooling duct 120, because water has a higher heat capacity than air and will be able to more effectively reduce the temperature of the stream of off-gas being extracted from the process vessel 101. Water will also keep the duct structure of the uptake apparatus 111 from overheating during upset conditions in the operation of process vessel 101. However, in other examples, the water-cooled duct 110 may be omitted, if the ambient-cooling duct 120 is able to sufficiently cool the stream of off-gas. In some examples, the ambient-cooling duct 120 may also be omitted if the off-gas is extracted from the process vessel 101 at a relatively low temperature.

Off-gas is directed in the semi-cooled off-gas stream 125 from the uptake apparatus 111 to the eductor apparatus 130. In some examples, the eductor apparatus 130 may take the form of a wye-junction, with two inlets and one outlet, as described in further detail below. The semi-cooled off-gas stream 125 and a recycle stream 185 enter the eductor apparatus 130 through separate inlets and with approximately co-current flow directions. The semi-cooled off-gas stream 125 is combined with the recycle stream 185 within the eductor apparatus 130, thereby cooling the semi-cooled off-gas stream 125 by dilution. An outlet stream 135 exits the eductor apparatus 130 at an intermediate temperature, between that of the semi-cooled off-gas stream 125 and the recycle stream 185. As an example, and not intended to be limiting, the temperature in the outlet stream 135 may be approximately 180° C., with an inlet temperature of about 450° C. for the semi-cooled off-gas stream 125 and an inlet temperature of about 40° C. for the recycle stream 185.

In some examples, in order to maintain a positive gauge pressure, ductwork employed to convey the streams 115, 125, 135 has a relatively large cross sectional area in order to reduce flow velocity and thereby limit static pressure losses. Furthermore, the same ductwork may employ low-pressure-drop fittings, for components such as elbows, flanges, and expansion joints, to limit static pressure losses within the streams 115, 125, 135.

The system 100 includes a gas conditioning train 210 for conditioning the outlet stream 135. In the example illustrated, the gas conditioning train 210 includes the off-gas fan 140 for pressurizing the off-gas, the dry dust collector 150 for cleaning the off-gas, and the cooler 160 for cooling the off-gas.

The off-gas fan 140 receives the outlet stream 135, increases the static pressure of the off-gas, and exhausts a pressurized off-gas stream 145. In some particular examples, the off-gas fan 140 may take the form of a variable-speed, direct-drive, centrifugal fan.

The dry dust collector 150 receives the pressurized off-gas stream 145 and filters out dust particles. In some examples, the dry dust collector 150 may include one or more baghouse filters. In other examples, the dry dust collector 150 may include one or more electrostatic precipitators, or a cyclone separator. A dry dust stream 152 is expelled from the dry dust collector 150 for further use, storage, or disposal. Off-gas is exhausted from the dry dust collector 150 in a clean off-gas stream 155.

The cooler 160 receives the clean off-gas stream 155 and cools the off-gas to a desired outlet temperature, and exhausts a conditioned off-gas stream 165. In some examples, the cooler 160 may take the form of a forced draft cooler having a vertical bank of tubes through which the off-gas flows. Fans blow ambient air horizontally across the outer surface of the tube bank, thereby cooling the off-gas circulating inside by forced convection. In other examples, the cooler 160 may take the form of a water-cooled heat exchanger. By way of example, and not intended to be limiting, the temperature of the conditioned off-gas stream 165 may be approximately 40° C.

In the system 100, the streams 115, 125, 135, 145, 155, 165 are generally maintained at a positive gauge pressure. It should be appreciated that the dry dust collector 150 may produce a relatively large pressure drop, and so arranging the dry dust collector 150 upstream from the off-gas fan 140 may risk producing a negative gauge pressure. Therefore, as illustrated, the off-gas fan 140 is arranged upstream of the dry dust collector 150, so that a positive pressure may be maintained. The cooler 160 may be placed upstream of the dry dust collector 150, but this arrangement may be less desirable because of the possibility of dust build-up within the cooler 160. Furthermore, cooling before removing the dust may cause volatile components to condense within the dry dust collector 150.

The conditioned off-gas stream 165 is separated into a recycle stream 175 and an outlet stream 200 by a junction 170. In various examples, the junction 170 may be a tee-junction, a wye-junction, or any other suitable flow splitting component. The outlet stream 200 is expelled from the system 100.

The recycle fan 180 receives the recycle stream 175, increases its static pressure, and exhausts the recycle stream 185 to be directed to the eductor apparatus 130. In some particular examples, the recycle fan 180 may take the form of a fixed-speed, direct-drive, centrifugal fan. In other examples, the off-gas fan 140 is powerful enough to produce a sufficiently high static pressure in the recycle stream 175, such that the recycle fan 180 is not required and may be omitted. In examples without the recycle fan 180, a damper component may be used to in place of the recycle fan 180, to control the flow rate of the recycle stream 185.

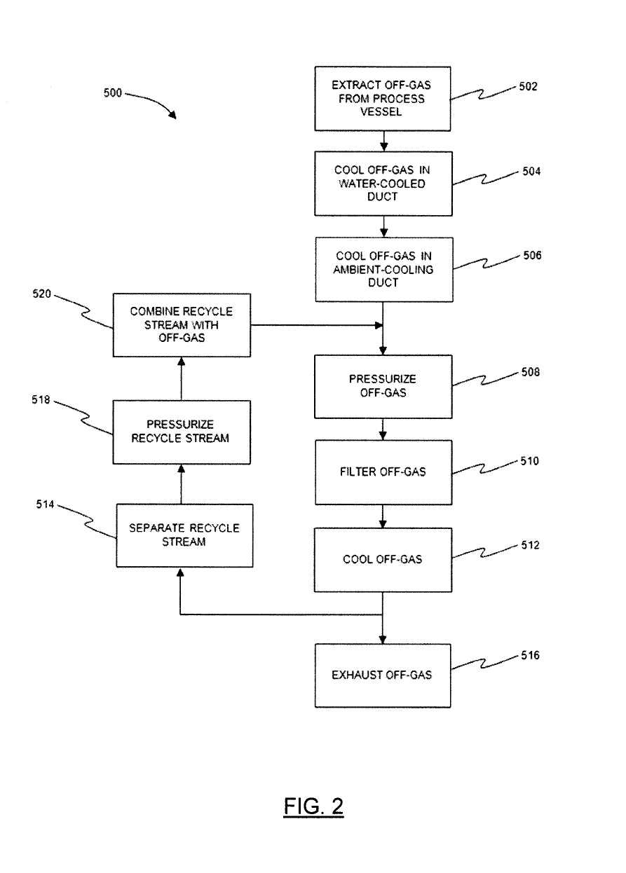

FIG. 2 generally illustrates a method 500 of using the system 100. In step 502, a stream of off-gas is extracted from a process vessel. In step 504, the off-gas is cooled in a water-cooled duct. In step 506, the off-gas is further cooled in an ambient-cooling duct. In step 508, the off-gas is pressurized, e.g., using a fan. In step 510, the off-gas is filtered. In step 512, the off-gas is further cooled. In step 514, the off-gas is separated to produce a recycle stream. In step 516, the remaining off-gas is exhausted from the system. In step 518, the recycle stream is pressurized, e.g., using a fan. Finally, in step 520, the recycle stream is combined with the off-gas, e.g., upstream from the step 508.

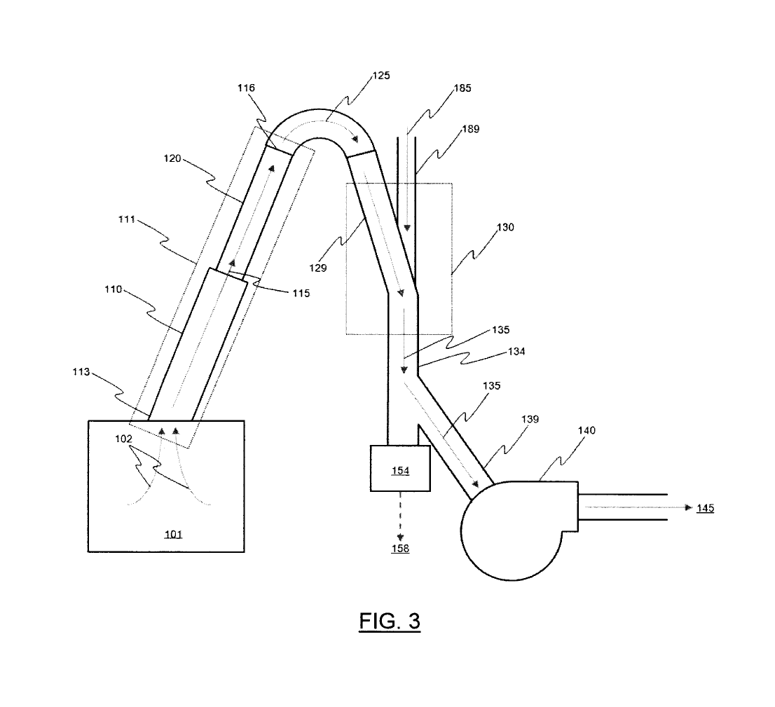

FIG. 3 shows the uptake apparatus 111 and the eductor apparatus 130 of the system 100. The uptake apparatus 111 includes the water-cooled duct 110, which is shown directly connected to an outlet of the process vessel 101, and the ambient-cooling duct 120, which extends directly from the outlet of the water-cooled duct 110.

Due to the sloping arrangement of the uptake apparatus 111, an off-gas stream 102 entering an inlet 113 of the uptake apparatus 111 is at a substantially lower elevation than the semi-cooled off-gas stream 125 exhausting from an outlet 116 of the uptake apparatus 111. Furthermore, due to the cooling of the off-gas stream 102 as it passes through the uptake apparatus 111, the semi-cooled off-gas stream 125 is substantially colder, and therefore denser, than the off-gas stream 102 at the inlet 113 of the uptake apparatus 111. This density difference results in an upward buoyancy-driven flow through the uptake apparatus 111. This movement of the off-gas, which may be described as “stack effect”, imparts a rise in static pressure in the system 100. Thus, the arrangement of the uptake apparatus 111 contributes to the positive gauge pressure of the system 10.

The semi-cooled off-gas stream 125 flowing from the outlet 116 of the uptake apparatus 111 is at higher temperature than the outlet stream 135, and will therefore tend to remain at the top of the uptake apparatus 111, due to buoyancy. As the semi-cooled off-gas stream 125 is forced from the outlet 116 towards the off-gas fan 140, this buoyancy causes the stack effect to operate in reverse, and results in a drop in static pressure. In some examples, an inlet of the off-gas fan 140 is arranged to be at a higher elevation than the inlet 113 of the uptake apparatus 111. This ensures that the stack effect imparts a net increase in static pressure between the inlet 113 of the uptake apparatus 111 and the off-gas fan 140. Furthermore, the temperature difference between the semi-cooled off-gas stream 125 and the off-gas stream 102 may be significantly higher than the temperature difference between the semi-cooled off-gas stream 125 and outlet stream 135, due to the high rate of cooling in the uptake apparatus 111. Consequently, the static pressure rise in the uptake apparatus 111 is generally greater than the subsequent static pressure drop between the outlet 116 and the off-gas fan 140, even if the inlet 113 of the uptake apparatus 111 and the inlet of off-gas fan 140 are at generally the same elevation.

In contrast to the uptake apparatus 111, the eductor apparatus 130 may be arranged in a downwardly sloping manner. In the example illustrated, the eductor apparatus 130 has two inlets streams: a semi-cooled off-gas stream 125 enters through an inlet duct 129; and the recycle stream 185 enters through a recycle inlet duct 189. The outlet stream 135 is expelled through an outlet duct 134, at an intermediate temperature between that of the semi-cooled off-gas stream 125 and that of the recycle stream 185. As an example of gas temperatures in the eductor apparatus 130, and not intended to be limiting, the semi-cooled off-gas stream 125 enters at 450° C., the recycle stream 185 enters at 40° C., and the outlet stream 135 is expelled at a temperature of 180° C.

Thus, it should be appreciated that the arrangement of the eductor apparatus 130 achieves two functions. Firstly, as mentioned, combination of the recycle stream 185 with the semi-cooled off-gas stream 125 results in the outlet stream 135 having a decreased temperature (compared to the semi-cooled off-gas stream 125). Secondly, combination of the recycle stream 185 with the semi-cooled off-gas stream 125 results in the outlet stream 135 having an increased static pressure (compared to the semi-cooled off-gas stream 125). Thus, the arrangement of the eductor apparatus 130 contributes to the positive gauge pressure of the system 10. Furthermore, the semi-cooled off-gas stream 125 will incur a continuous drop in static pressure as it flows from the outlet 116 of the uptake apparatus 111 to the off-gas fan 140, due to frictional forces and negative stack effect (if applicable). Consequently, an area immediately upstream of the off-gas fan 140 may be most susceptible to dropping below atmospheric pressure, and so arranging the eductor apparatus 130 in this area may reduce the risk of a negative gauge pressure in the outlet stream 135.

The uptake apparatus 111, the eductor apparatus 130, the inlet duct 129, the recycle inlet duct 189, the outlet duct 134, and an off-gas fan inlet duct 139 are illustrated in FIG. 3 to be in vertical or near-vertical orientations. This arrangement may reduce the settling and collection of dust on the bottom surfaces of these components, which may occur when dusty gas mixtures pass through horizontal duct segments. In some examples, an inclination of 60° above horizontal or more may be implemented with these components to prevent dust collection.

With continued reference to FIG. 3, a drop-out box 154 may be arranged downstream of the eductor apparatus 130, and upstream of the off-gas fan 140. The outlet duct 134 may be oriented in a generally vertical direction such that the outlet stream 135 flows in a vertically downward direction. The drop-out box 154 may be positioned directly below the outlet duct 134 such that the more massive dust particles entrained in the outlet stream 135 tend to collect in the drop-out box 154 rather than continuing through the off-gas fan inlet duct 139 to the off-gas fan 140. Dust collected in the drop-out box 154 may be expelled as a dry dust stream 158, for further use or disposal.

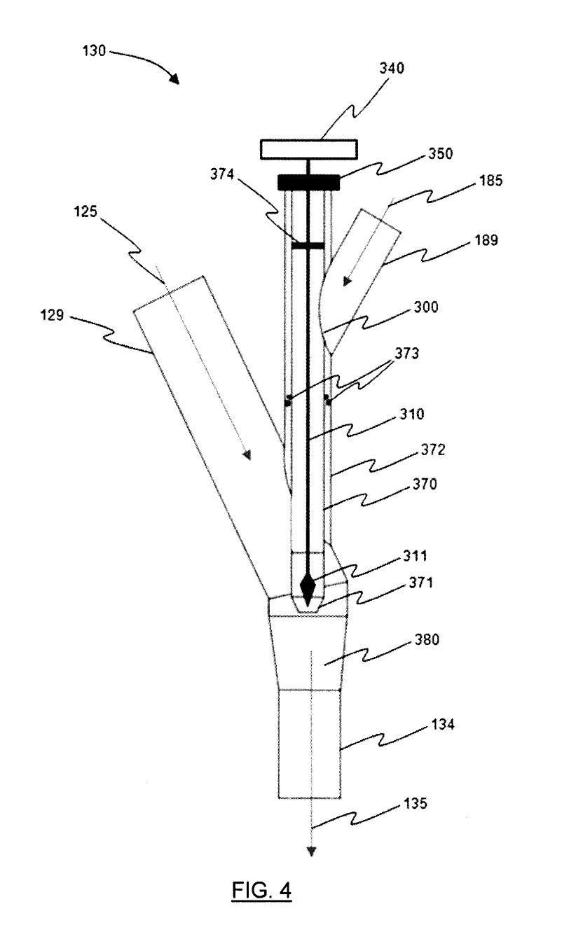

Referring now to FIG. 4, the semi-cooled off-gas stream 125 enters the eductor apparatus 130 through the inlet duct 129. Similarly, the recycle stream 185 enters the eductor apparatus 130 through the recycle inlet duct 189. The eductor apparatus 130 includes an inner vertical duct 370 with a tapered throat 371 at a lower end thereof. A shaft 310 running the length of the inner vertical duct 370 is attached at its lower end to a conical member 311. The shaft is retained in the inner vertical duct 370 by an axial alignment guide 374. The upper end of the shaft 310 extends above a shaft flange seal 350, and is attached to a linear actuator 340.

An outer vertical duct 372 surrounds the inner vertical duct 370 and defines an annular plenum therebetween, which includes seals 373 to prevent off-gas from travelling upwards through the plenum. In the event of trouble with operation of the shaft 310, the conical member 311 and/or the throat 371, the inner vertical duct 370 may be removed from the eductor apparatus 130 for servicing. With the inner vertical duct 370 removed, the recycle stream 185 may continue to be fed generally into a mixing duct 380 by the outer vertical duct 372.

The recycle stream 185 enters the inner vertical duct 370 of the eductor apparatus 130 through a channel 300. The recycle stream 185 flows vertically downward through the channel 300 and the inner vertical duct 370, and is expelled into the mixing duct 380 through the throat 371. The cross sectional area of the throat 371 may be adjusted by varying a vertical position of the conical member 311, for example, using the linear actuator 340, to control flow velocity of the recycle stream 185 at the outlet of the throat 371. Adjustability may ensure that the flow velocity at the outlet of the throat 371 is adequate during turndown conditions, when considerably lower flow rates occur for the semi-cooled off-gas stream 125 and the recycle stream 185.

The recycle stream 185 accelerated by the throat 371 is expelled into the mixing duct 380, where it mixes with the semi-cooled off-gas stream 125 in an approximately co-current flow arrangement. Heat is transferred from the semi-cooled off-gas stream 125 to the recycle stream 185 (of a lower temperature), producing the outlet stream 135 which is at an intermediate temperature. Furthermore, momentum is transferred from the recycle stream 185 to the semi-cooled off-gas stream 125 (of a lower velocity), thereby increasing static pressure of the outlet stream 135 relative to the semi-cooled off-gas stream 125. In some examples, the increase in the static pressure may be optimized by varying the area, and therefore flow velocity, of the throat 371 in response to given operating conditions.

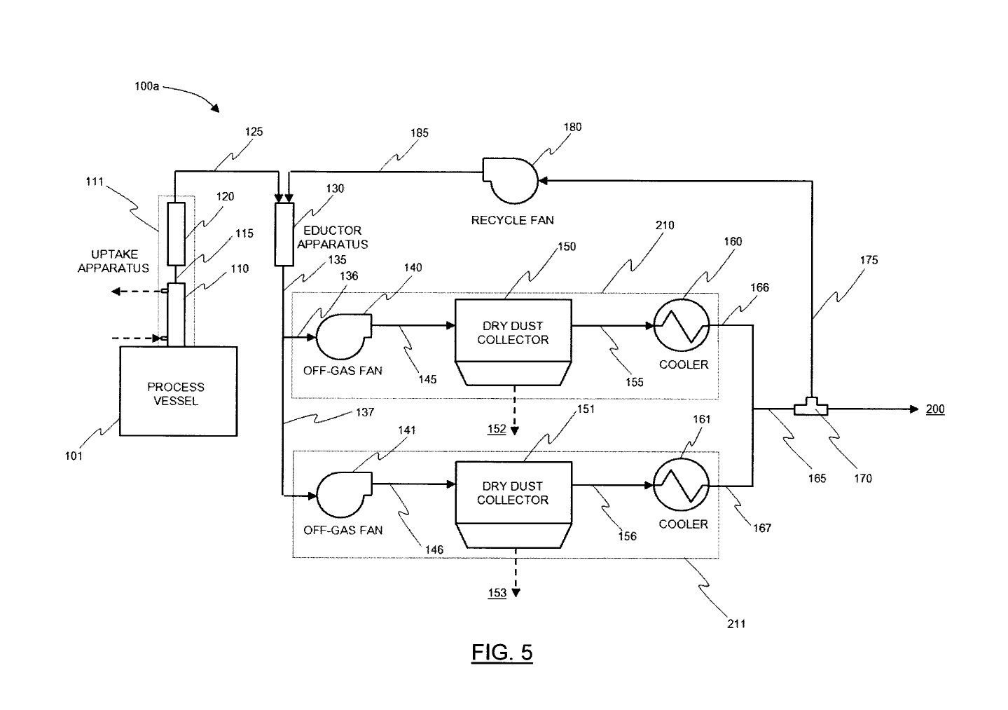

Referring now to FIG. 5, another example of a gas handling system is illustrated generally at 100a. The system 100a is similar to the system 100 of FIG. 1, with the system 100a including a parallel gas conditioning train 211.

In the example illustrated, the outlet stream 135 is separated into secondary outlet streams 136 and 137, such that subsequent pressurization, cleaning, and cooling stages are performed generally in parallel by two trains. In other examples, three gas conditioning trains may be implemented, or even more.

The first secondary outlet stream 136 is pressurized by the off-gas fan 140, cleaned by the dry dust collector 150, and cooled by the cooler 160 (generally as described above with reference to the system 100) to produce a first conditioned off-gas stream 166. Similarly, in the parallel gas conditioning train 211, the second secondary outlet stream 137 is pressurized by an off-gas fan 141, to produce a pressurized off-gas stream 146. The pressurized off-gas stream 146 is cleaned by a dry dust collector 151, to produce a clean off-gas stream 156. The clean off-gas stream 156 is cooled by a cooler 161 to produce a second conditioned off-gas stream 167. A secondary dry dust stream 153 is expelled from the dry dust collector 151 for further use, storage, or disposal (along with the dry dust stream 152). The first and second conditioned off-gas streams 166, 167 are combined to form the conditioned off-gas stream 165.

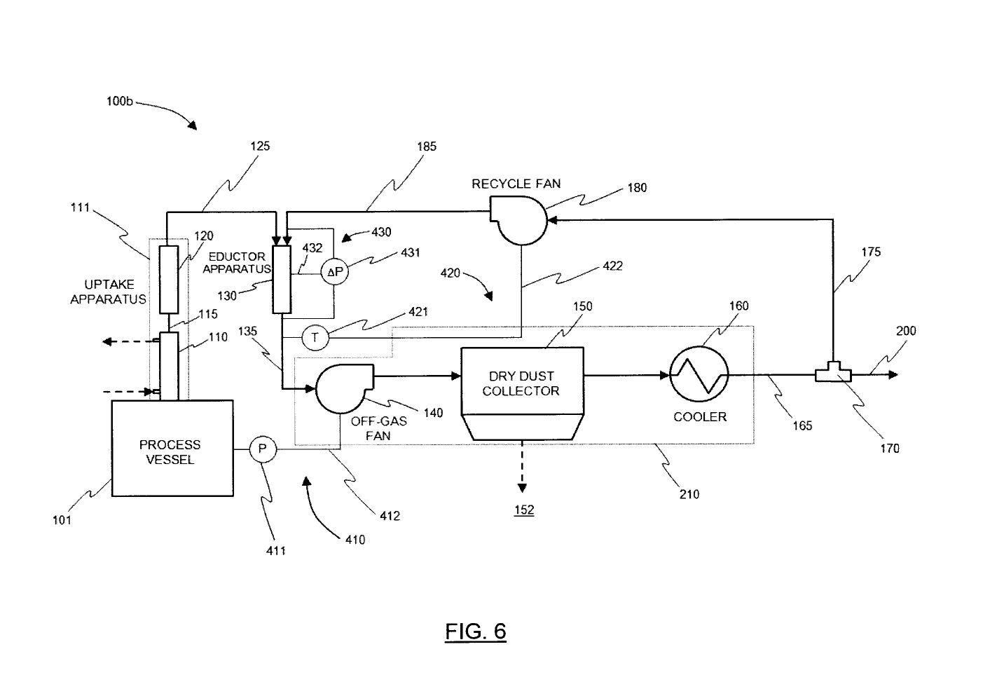

Referring now to FIG. 6, another example of a gas handling system is illustrated generally at 100b. The system 100b is similar to the systems 100, 100a, with the system 100b further including additional instrumentation to control off-gas temperatures and pressures.

In particular, a pressure control loop 410 may include a pressure measurement device 411, which monitors pressure of the process vessel 101, and a connection 412 to the off-gas fan 140. The pressure measurement device 411 may include one or more transducers. Based on pressure readings from the pressure measurement device 411, a flow rate at the off-gas fan 140 may be adjusted in order to maintain pressure in the process vessel 101 at a desired setpoint. In some examples, the flow rate of the off-gas fan 140 may be adjusted using a bypass damper apparatus, which may consist of a bypass duct which branches off an outlet duct of the off-gas fan 140 and returns to an inlet duct of the off-gas fan 140, allowing recirculation. A variable damper located within the bypass duct controls the flow of recirculation gas.

Furthermore, a temperature control loop 420 may include a temperature measurement device 421, which monitors temperature of the outlet stream 135, and a connection 422 to the recycle fan 180. The temperature measurement device 421 may include one or more transducers. Based on temperature readings from the temperature measurement device 421, the flow rate of the recycle fan 180 may be adjusted in order to maintain the temperature of the outlet stream 135 at a desired setpoint. In some examples, the flow rate of the recycle fan 180 may be adjusted using a bypass damper apparatus, such as the apparatus described for the off-gas fan 140. In order to decrease the temperature of the outlet stream 135, the flow rate of the recycle fan 180 may be increased such that a larger volume of the recycle stream 185 is mixed with the semi-cooled off-gas stream 125. Conversely, in order to increase the temperature of the outlet stream 135, the flow rate of the recycle fan 180 may be reduced such that a smaller volume of the recycle stream 185 is mixed with the semi-cooled off-gas stream 125. For example, the temperature control loop 420 may be used to maintain the temperature of the outlet stream 135 at about 180° C.

Moreover, a differential pressure control loop 430 may include a differential pressure measurement device 431, which monitors pressure differential between the recycle stream 185, the outlet stream 135, and a connection 432 to the eductor apparatus 130. The differential pressure measurement device 431 may include one or more transducers. Based on pressure readings from the differential pressure measurement device 431, the area of the throat 371 of the eductor apparatus 130 (shown in FIG. 4) may be adjusted in order to optimize the increase in static pressure in the outlet stream 135 for the given pressure differential.

It will be appreciated by those skilled in the art that many variations are possible within the scope of the claimed subject matter. The examples that have been described above are intended to be illustrative and not defining or limiting.

1. A system for handling an off-gas containing carbon monoxide at a positive gauge pressure, the system comprising:
an uptake apparatus for extracting a stream of the off-gas from a process vessel;
at least one gas conditioning train, for receiving and conditioning the stream;
a junction for separating the stream to form at least a recycle stream and an outlet stream;
an outlet for expelling the outlet stream; and
an eductor apparatus for receiving and combining the stream with the recycle stream, to decrease the temperature and increase the static pressure of the stream.

2. The system of claim 1, wherein the eductor apparatus is arranged upstream from the at least one gas conditioning train.

3. The system of claim 2, wherein the eductor apparatus comprises a first inlet duct for receiving the stream, a second inlet duct for receiving the recycle stream, and an outlet duct for expelling the stream.

4. The system of claim 3, wherein the outlet duct is oriented generally vertically so that the stream is expelled generally in a vertically downward direction.

5. The system of claim 4, further comprising a drop-out box positioned below the outlet duct for receiving dust particles entrained in the stream.

6. The system of claim 3, wherein the eductor apparatus comprises a throat, and the recycle stream is expelled through the throat.

7. The system of claim 6, wherein a cross sectional area of the throat is adjustable to control a flow velocity of the recycle stream.

8. The system of claim 7, wherein the cross sectional area is adjusted by varying a vertical position of a conical member within the throat.

9. The system of claim 1, further comprising a recycle fan for receiving the recycle stream from the junction and pressurizing the recycle stream.

10. The system of claim 1, wherein the uptake apparatus is adapted to cool the stream.

11. The system of claim 10, wherein the uptake apparatus comprises a water-cooled duct.

12. The system of claim 11, wherein the uptake apparatus comprises an ambient-cooling duct.

13. The system of claim 12, wherein the water-cooled duct and the ambient-cooling duct are connected in series.

14. The system of claim 10, wherein the uptake apparatus is arranged so that an outlet of the uptake apparatus is at a higher elevation than an inlet of the uptake apparatus.

15. The system of claim 1, wherein the at least one gas conditioning train comprises an off-gas fan for pressurizing the stream, a dry dust collector for cleaning the stream, and a cooler for cooling the stream.

16. The system of claim 15, wherein the off-gas fan receives the stream from the eductor apparatus, the dry dust collector receives the stream from the off-gas fan, and the cooler receives the stream from the dry dust collector.

17. The system of claim 16, wherein the off-gas fan is arranged so that an inlet of the off-gas fan is at a higher elevation than an inlet of the uptake apparatus.

18. The system of claim 1, comprising two or more of the gas conditioning trains.

19.-32. (canceled)
